(19) United States
(12) Patent Application Publication
(10) Pub. No.: US 2012/0032834 A1
(43) Pub. Date: Feb. 9, 2012

(54) USE OF ACCELEROMETER AND ABILITY TO DISABLE POWER SWITCH FOR TAMPER PROTECTION AND THEFT TRACKING

(76) Inventor: Steven V. Weeks, North Andover, MA (US)

(21) Appl. No.: 13/163,124

(22) Filed: Jun. 17, 2011

Related U.S. Application Data
(60) Provisional application No. 61/371,823, filed on Aug. 9, 2010.

(51) Int. Cl. G01S 13/08; G06F 21/00; H04Q 5/22

(52) U.S. Cl. 342/118; 340/10.1; 726/36

(57) ABSTRACT

Embodiments disclosed herein include a sensor device that monitors external activity and that includes functionality to detect tampering of the device itself. When monitoring for tampering, a power switch is disabled. Techniques include detecting relative movement of the sensor device, reporting tampering activity, and executing tamper detection responses. Responses can include tracking geographical movement and/or subsequent tampering activity to assist in recovery of a transported device. Responses can also include adjusting power consumption such as by modifying sensing functionality of the sensor device. Techniques include use of an accelerometer that can be positioned in the sensor device to detect relative movement. Once relative movement meets a predetermined threshold indicating device tampering, the sensor device transmits a notification of such tampering, via a network, or in response to a query from an authorized peer device.

### CROSS REFERENCE TO RELATED APPLICATIONS

The present application claims the benefit of the filing date of earlier filed U.S. Provisional Application for patent having U.S. Ser. No. 61/371,823, filed Aug. 9, 2010 entitled “USE OF ACCELEROMETER AND ABILITY TO DISABLE POWER SWITCH FOR TAMPER PROTECTION AND THEFT TRACKING.” The entire teaching, disclosure and contents of this provisional patent application are hereby incorporated by reference in their entirety.

### BACKGROUND

The present disclosure relates to systems and methods that address tampering of objects. Detecting tampering—and/or preventing tampering—is important for a variety of applications and for several of reasons. For example, it is important to detect if food has been tampered with for safety reasons. Additionally, it is important to protect documents from being tampered with to prevent fraud or loss. Likewise, it is important to detect tampering in electronic devices, including sensor devices.

Sensor devices are devices for detecting various types of activity and/or measuring a physical quantity of input or matter. Such activity can be environmental or external to the sensor device. Sensor devices typically operate in either an active or passive state to monitor a particular type of input, analyze collected data, and possibly report on collected data. There are various types of sensors for use in many different applications. For example, one type of sensor is a radar sensor. Radar is an object detection system that uses electromagnetic waves to identify range, altitude, direction, and/or speed of both moving and fixed objects such as aircraft, ships, motor vehicles, weather formations, terrain and people. Radar is sometimes referred to as radio detection and ranging. Conventional radar systems have a transmitter that emits radio waves. When transmitted radio waves contact an object the radio waves are scattered in all directions. A portion of the radio waves is thus reflected back towards the radar system. Reflected radio waves have a slight change of wavelength (and thus frequency) if the target is moving. Radar systems also include a receiver. The receiver is typically located in a same location as the transmitter. Although the reflected signal is usually very weak, the reflected signal can be amplified through use of electronic techniques in the receiver and in the antenna configuration. Such amplification enables a radar unit to detect objects at ranges where other emissions from a target object, such as sound or visible light, would be too weak to detect. Accordingly, radar sensors can be used for meteorological detection of precipitation, measuring ocean surface waves, air traffic control, police detection of speeding traffic, and military applications.

Another type of sensor device is a seismic sensor. Seismic sensors can detect, measure, and analyze the propagation of seismic waves though the earth or other substantially solid (or fluid) objects. Seismic sensors are useful to detect many sorts of activity such as earthquakes, foot traffic, excavation, motion of vehicles, etc. Another type of sensor is an acoustic senor. Acoustic sensors (or audio sensors) can detect and measure or record sounds waves that typically travel though air. This can include gunshot detection systems. Another type of sensor is a wireless network detection sensor that can detect presence of transmitted radio waves. Another type of sensor is a visual sensor, which can be used to capture still images, moving images, or otherwise detect motion with visual light as an input. Another type of sensor is a passive infrared sensor that can capture and/or detect presence of infrared light and corresponding movement. Thus, there are various types of sensors for monitoring various types of activity, which activity is typically external to the sensor device itself.

### SUMMARY

One challenge with particular sensors devices (such as radar, acoustic, seismic, etc.) is that the sensors can be sensitive to movement of the device itself. Thus, it can be important for sensors to remain undisturbed in a given placement location or position. Keeping a device undisturbed can be more challenging when sensors are relatively small in size. For example, conventional radar systems have been large, heavy units, primarily intended for permanent installation around a perimeter to be protected or mounted on specialized equipment. In other words, such conventional sensors are essentially not portable or not easily portable. Radar sensor devices and other sensor devices developed in association with this disclosure, however, include sensor devices that are relatively compact units and thus easily portable by hand. Such compact radar systems can include one or more portable radar devices that can be positioned and repositioned at various locations. Individual radar sensor devices can be sized relatively smaller than conventional radar units. For example, a given compact radar device (or acoustic sensor device, seismic sensor device, infrared sensor device, etc.) can be sized similar to the size of a beverage can or bottle. Such compact radar sensors can offer superior size and weight characteristics, and exceptional target detection and localization capabilities. Such systems can also employ low-power networking capability for communications, allowing for both remote system control as well as data filtration for remote use by handheld devices. Thus, each sensor device can be a link in a chain of sensors, a node within a network or array of sensors, or a stand-alone data collection unit.

While the relatively compact size of such sensors enables easier deployment and portability, the portability itself raises challenges in protecting the sensor device from tampering. For example, a given sensor device might be placed on the ground, partially in the ground, mounted on a tree or secured to a structure, etc. After the sensor device is positioned for sensing, and whichever corresponding sensing function(s) is initiated, it can be important for the device to remain undisturbed for accurate sensing operations and data collection. Unfortunately, the simple act of physically lifting the sensor device, turning the sensor device, or carrying the sensor device away from the placement location can compromise or disable accurate sensing of external activity. Tamper protection measures in the context of techniques to prevent tampering of the device, can be considered impractical because of device size. For example, a given sensor device can be constructed with a durable housing that is difficult to breach, yet merely lifting or moving the sensor device itself can disrupt, disable, or otherwise compromise sensor functionality. In other words, simply lifting an active sensor device can be considered tampering.

Depending on a placement locations, technicians placing sensor devices can attempt to hide or visually conceal sensor devices, but hiding is not always an available option, and concealing some sensors can reduce sensing functionality or radio communications with peer devices. Whether hidden or not, sensor devices can be discovered and disturbed by unauthorized persons, who may attempt to power-off the sensor and/or disassemble the sensor. In addition to such manual disturbances, sensor devices can also be disturbed as a result of natural occurrences. For example, a sensor device at a given location can be disturbed by wind, ground movement, weather, or even animals. Whether a disturbance is a result of a person or a natural occurrence, it is desirable to detect when tampering has occurred so that a tampered with sensor device can be repositioned, recovered, replaced, or otherwise addressed. Since tamper prevention is not always practical, techniques disclosed herein enable tamper detection and response.

Techniques disclosed herein provide effective tamper detection methods and systems that can both detect tampering and respond to tampering. Techniques include detecting relative motion of a given sensor device itself, reporting tampering activity, tracking movement and/or subsequent tampering activity, as well as modifying sensing functionality of the sensor device itself. Techniques include use of an accelerometer that can be positioned in a sensor device to detect relative movement of the sensor device. Once relative movement is detected such that the movement is considered tampering, the sensor device can transmit a notification of such tampering. The notification can be transmitted automatically via a network, or in response to a query from an authorized peer device. The sensor device can also track geographical movement to assist in recovery of a removed device. The sensor device can also transition to a tamper detection response mode (state) that can include reducing or eliminating sensing functionality, reducing or eliminating radio communications, and generally conserving battery power for devices powered by batteries.

In one embodiment, a sensor device includes a processor, a memory coupled to the processor, power circuitry configured to receive a supply of power, and a sensor configured to detect activity external to the sensor device, such as radar activity, seismic activity, acoustic activity, visual activity, cell phone activity, and so forth. The sensor device also include an accelerometer configured to detect relative movement of the sensor device, that is, to detect whether the device has been rattled, shaken, bumped, turned, moved, etc. The memory can store instructions such that when the processor executes the instructions, the instructions cause the sensor device to perform several operations. For example, the sensor device can monitor (using the sensor) activity external to the sensor device by measuring physical inputs including various types of waves (sound, seismic, electromagnetic). Such monitoring can begin after receiving a command to arm the sensor device (activate sensing functionality). The sensor device can initiate a tamper monitoring state that includes monitoring relative movement data of the sensor device. This relative movement data is received from the accelerometer. The tamper monitoring state can include disabling use of a manual power shutoff switch of the sensor device. Disabling use of a manual power shutoff switch can occur in response to arming the sensor device (activating sensing functionality). After disabling use of a manual power shutoff switch, any attached button, knob, or external power switch becomes useless regardless of how an unauthorized person manipulates the external power switch. Thus, although an unauthorized person may think that he was able to turn off the sensor device via the external power switch, the sensor device will remain powered-on during the tamper monitoring state. The sensor device can thereby continue to determine and store its current location, thereby tracking geographical and relative device movement, and route of the unauthorized person as the unauthorized person transports the sensor device.

In response to detecting movement of the sensor device meeting a predetermined threshold of movement, the device executes a tamper detection response. The tamper detection response includes transmitting a notification that indicates sensor device movement meeting the predetermined threshold of movement, and/or initiating a low-power state of the sensor device. The low-power state can include stopping functionality of the senor and/or other modules of the sensor device, or reducing frequency of sensing and/or communication functionality.

In another embodiment, a method includes a tamper manager for communicating tampering information of a sensor device and for managing a tamper response. The tamper manager can function as an application or software process. Accordingly, the tamper manager, or sensor device can execute the operations described above.

In another embodiment, a radar sensor device includes several modules or components including power circuitry configured to receive a supply of power from at least one battery, a radar signal transmitter configured to transmit radar signals, and a radar signal receiver configured to receive reflected radar signals. The radar device also includes a processor such that the processor is configured to compute radar data from received reflected radar signals, with computed radar data including a distance to an external object. The radar device also includes radio circuitry configured to execute wireless communications including communication transmissions with peer devices, Global Positioning System (GPS) circuitry configured to identify location information of the radar sensor device, and an accelerometer configured to detect relative movement of the radar sensor device. The radar device also has memory coupled to the processor, with the memory storing instructions that, when executed by the processor, cause the radar sensor device to perform several operations. For example, the radar device collects radar data that identifies distance of external objects. The radar device initiates a tamper monitoring state that includes monitoring relative movement data of the radar sensor device, with the relative movement data received from the accelerometer. The tamper monitoring state includes disabling use of a manual power shutoff switch of the radar device. Disabling use of the manual power shutoff switch can occur in response to activating radar sensing (arming the device). If the radar device detects relative movement of the radar sensor device itself meeting a predetermined threshold of movement, then the radar device executes a tamper detection response. The tamper detection response can include immediately transmitting a tampering notification via the radio circuitry. The notification indicates radar sensor device movement meeting the predetermined threshold of movement. The radar device can also initiate a low-power state of the radar sensor device that includes reducing power consumption of the radar signal transmitter and the radar signal receiver. Note that all of the various device components can be directly or indirectly connected to the processor, which processor can include a single, processor, or multiple microprocessors.

Yet other embodiments herein include software programs to perform the steps and operations summarized above and disclosed in detail below. One such embodiment comprises a computer program product that has a computer-storage medium (e.g., a non-transitory, tangible, computer-readable media, disparately located or commonly located storage media, computer storage media or medium, etc.) including computer program logic encoded thereon that, when performed in a computerized device having a processor and corresponding memory, programs the processor to perform the operations disclosed herein. Such arrangements are typically provided as software, firmware, microcode, code data (e.g., data structures), etc., arranged or encoded on a computer readable storage medium such as an optical medium (e.g., CD-ROM), floppy disk, hard disk, one or more ROM or RAM or PROM chips, an Application Specific Integrated Circuit (ASIC), a field-programmable gate array (FPGA) and so on. The software or firmware or other such configurations can be installed onto a computerized device to cause the computerized device to perform the techniques explained herein.

Accordingly, one particular embodiment of the present disclosure is directed to a computer program product that includes one or more non-transitory computer storage media having instructions stored thereon for supporting operations such as: monitoring, via a sensor device, activity external to the sensor device, the sensor device including a sensor that detects external activity, the sensor device including an accelerometer that detects relative movement of the sensor device, the sensor device including communication circuitry that transmits and receives communication transmissions via a communication interface; initiating a tamper monitoring state that includes monitoring relative movement data of the sensor device, the relative movement data received from the accelerometer, the tamper monitoring state including disabling use of a manual power shutoff switch of the sensor device; in response to detecting movement of the sensor device meeting a predetermined threshold of movement, executing a tamper detection response, the tamper detection response comprising: transmitting a notification that indicates relative movement of the sensor device meeting the predetermined threshold of movement; and initiating a low-power state of the sensor device. The instructions, and method as described herein, when carried out by a processor of a respective computer device, cause the processor to perform the methods disclosed herein.

Other embodiments of the present disclosure include software programs to perform any of the method embodiment steps and operations summarized above and disclosed in detail below.

Of course, the order of discussion of the different steps as described herein has been presented for clarity sake. In general, these steps can be performed in any suitable order.

Also, it is to be understood that each of the systems, methods, apparatuses, etc. herein can be embodied strictly as a software program, as a hybrid of software and hardware, or as hardware alone such as within a processor, or within an operating system or within a software application, or via a non-software application such a person performing all or part of the operations. Example embodiments as described herein may be implemented in products and/or software applications such as those manufactured by Raytheon BBN Technologies Corp., Cambridge, Mass.

As discussed above, techniques herein are well suited for use in software applications supporting radar and sensor device deployment applications. It should be noted, however, that embodiments herein are not limited to use in such applications and that the techniques discussed herein are well suited for other applications as well.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives of the invention and embodiments, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein as illustrated in the accompanying drawings in which like reference characters refer to the same parts throughout the different views. The drawings are not necessarily to scale, with emphasis instead being placed upon illustrating the embodiments, principles and concepts.

FIG. 1 is an illustration of an example sensor device according to embodiments herein.

FIG. 2 is a diagram showing relative movement of a sensor device representing tampering, and showing a tamper response according to embodiments herein.

FIG. 3 is a block diagram of example system architecture for a sensor device that includes an accelerometer according to embodiments herein.

FIGS. 4-6 are flowcharts illustrating an example process supporting tampering monitoring and response according to embodiments herein.

### DETAILED DESCRIPTION

Techniques disclosed herein provide effective tamper detection and response to detected tampering. Techniques include detecting relative motion of a given sensor device itself, reporting tampering activity, tracking movement and/or subsequent tampering activity, as well as modifying sensing functionality of the sensor device itself. Techniques include use of an accelerometer that can be positioned in a sensor device to detect relative movement of the sensor device. Once relative movement (a change in relative movement) is detected such that the movement is considered tampering, the sensor device can transmit a notification of such tampering, such as via a network or in response to a query from an authorized peer device. The sensor device can also track geographical movement to assist in recovery of a removed device. The sensor device can also transition to a tamper detection response mode (state) that can include reducing or eliminating sensing functionality, reducing or eliminating radio communications, and conserving battery power in general.

Such techniques are useful for detecting tampering of sensor devices. For example, radar sensors, and other types of sensors that measure electromagnetic or physical waves, function better when sensors have not been moved, bumped, or otherwise disturbed. Small amounts of movement can be acceptable. For example, if a sensor was mounted on a tree and the tree sways slightly, this could be deemed as acceptable movement. If a radar sensor, however, was moved several inches or feet, turned, lifted, shaken, transported, etc., then such movement can be deemed as tampering. Such disturbances can cause an active sensor to become useless for several minutes or more (unable to collect data) until the sensor is able to reestablish a reference frame for measuring external activity.

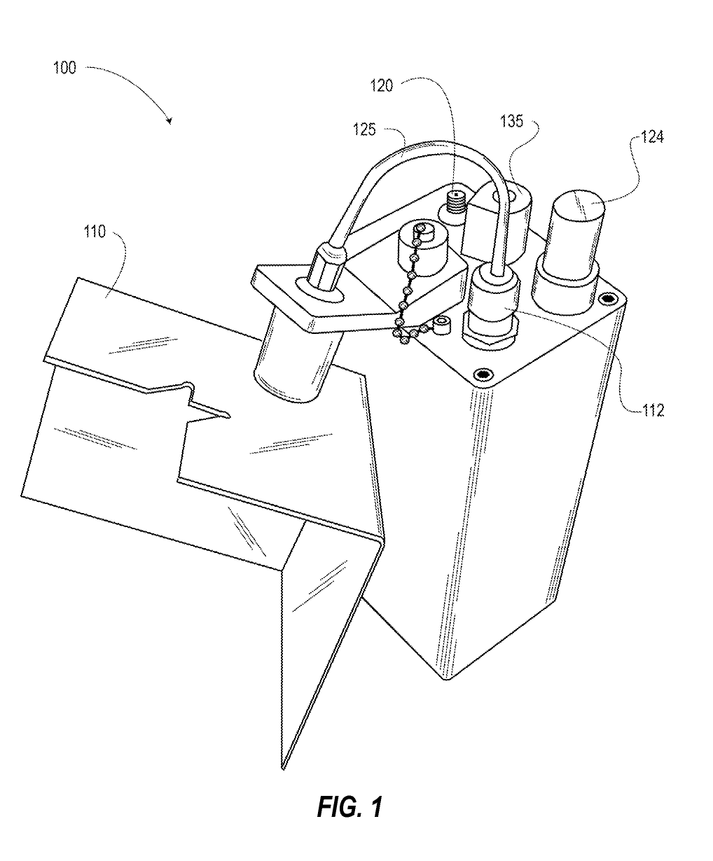

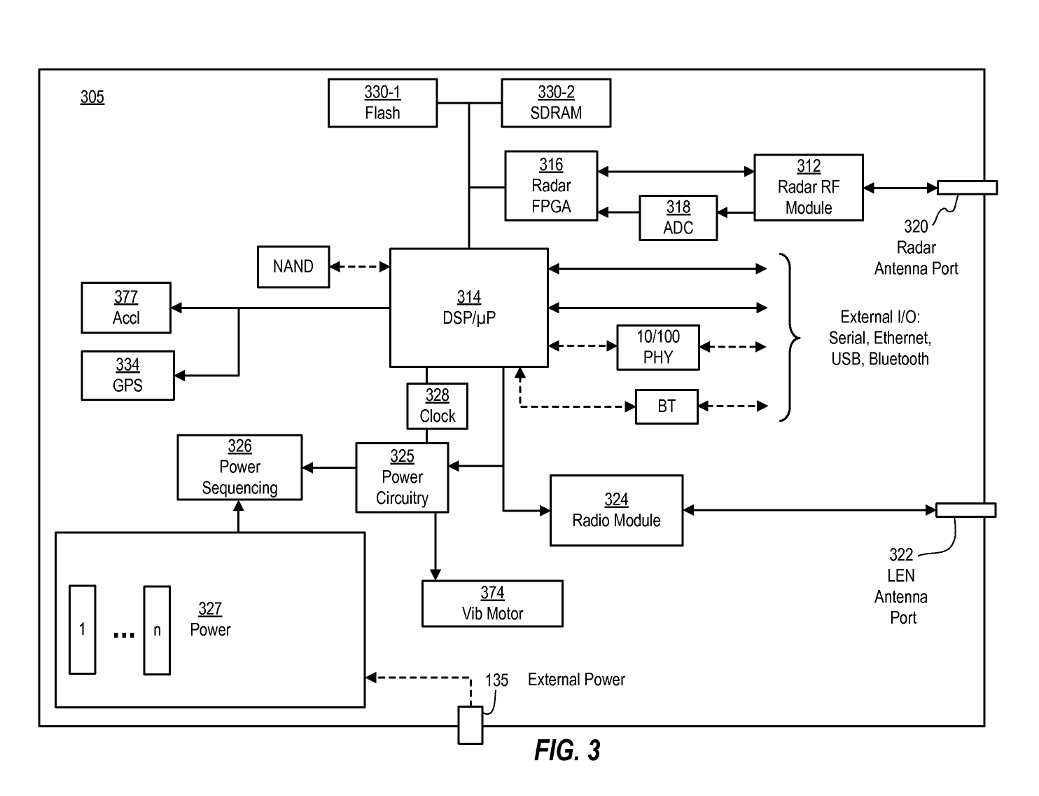

Referring now to FIG. 1 in conjunction with FIG. 3, FIG. 1 depicts an example sensor device 100 having different types of transmission functionality (radar, radio, GPS). Note that for convenience in describing example embodiments, this disclosure will primarily reference radar sensors. Nevertheless, sensor devices can be embodied with other types of sensors for detecting external data, as well as a combination of sensors. Sensor device 100 can receive and transmit radar signals using radar antenna 110 and radar antenna port 112 and connector 125. The example illustration shows radar antenna 110 mounted to sensor device 100. In alternative embodiments, the radar antenna 110 can be positioned away from sensor device 100, such as being positioned in a tree while being connected to sensor device 100 via radar antenna port 112. Sensor device 100 can also receive and transmit radio communications via radio antenna port 120. Radio antenna port 120 can be used to receive wireless signals on a short-range radio frequency band, such as from a relatively proximate location. Radar antenna 110 can double as a radio antenna. Alternatively, a separate radio antenna can be used with radio port 120. Both the radar and radio antennas can be attached to the device 100 remotely via a cable. GPS antenna 124 can be used to provide location information. Power switch 135 can be used to power-on or power-off sensor device 100. The various modules and components that can be included in sensor device 100 are described below in reference to FIG. 3. FIG. 3 shows an accelerometer 337 within sensor device 100 for detected relative motion of the sensor device.

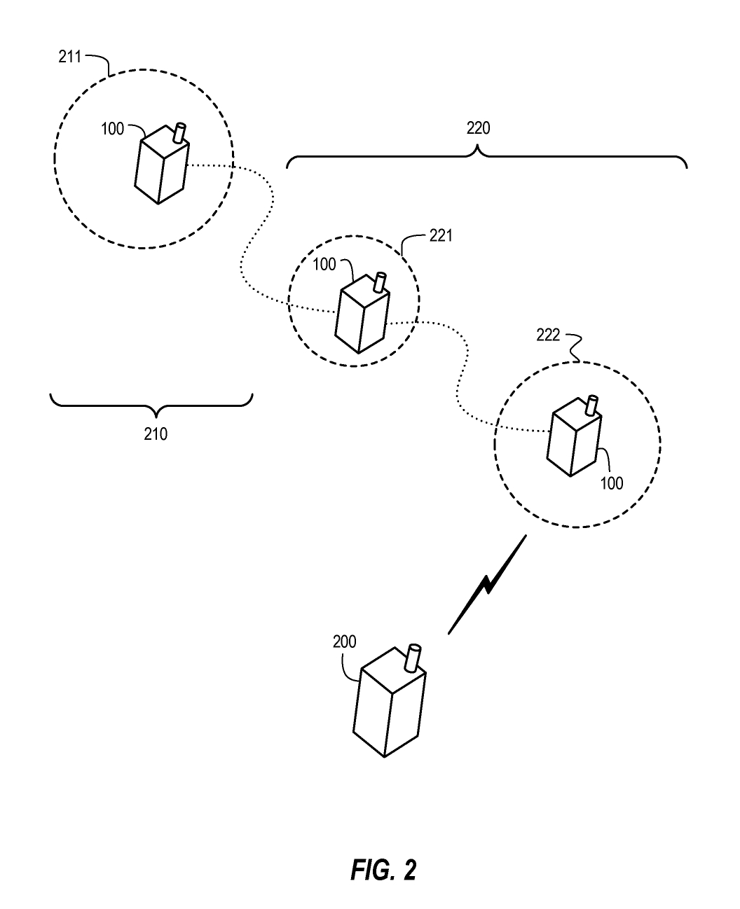

FIG. 2 depicts, in general, an example sensor device being tampered with or moved. Physical location 211 represents a desired physical placement location, with sensor device 100 being positioned at location 211. Such a placement location can be near a road, path, building, or geographical area of particular interest. Sensor device 100 can be physically placed in or on the ground, mounted to a tree or building, concealed in brush, etc. Some sensor devices can operate independent of a network (or at least a constantly-available network). For example, a sensor can be placed at a specific location of importance, which may be isolated from other devices or technicians. The sensor then collects data and waits for an interrogation device to come within range to request collected data (such as by a vehicle driving within range). By way of a non-limiting example, a given sensor device could be placed at a culvert or a remote entrance to an area and independently collect movement data. A sensor reader or other authorized peer device 200, when in close physical proximity (such as a user approaching the placement site) can then wirelessly interrogate the sensor to determine activity that the sensor has recorded, which can be used to determine if they physical location has been visited and thus potentially compromised or dangerous.

Upon positioning sensor device 100 at placement location 211, the sensor device 100 can be armed or otherwise commanded to commence sensor functionality to monitor external activity (such as movement of people or vehicles, ground vibration, sound, etc.). The device can be armed in several ways. One way is by powering on the device using power switch 135. In some embodiments, simply powering-on the sensor device will not arm the device. For example, it may be necessary to first confirm that a placed sensor device can properly detect external activity and/or connect to any associated network. This may involve repositioning the sensor device or selecting a different placement location for satisfactory communication with a network or satisfactory sensor readings. After it is determined that the sensor device is satisfactorily positioned, the sensor device can be armed. Arming the device can be executed using a variety of mechanisms. For example, arming can occur in response to receiving an arming signal from a network or central control unit, from manual input from the device itself, or from a signal received via a personal area network (Bluetooth connection). For any given sensor array or configuration, arming can occur one-by-one in conjunction with placing each respective sensor, or simultaneously, such as after placement of a given sensor array, such as with a signal transmitted from a remote command and control device or other user interface unit (local or remote). Once the device is armed, the device can report movement activity to a corresponding network or control unit, which can be immediate reporting. Arming the device causes the sensor device to initiate a tampering monitoring state 210. Once armed, the power switch 135 is ignored or otherwise pulled from the circuit so that the power switch is useless for manual use.

Tamper monitoring state 210 is a device mode in which the sensor device analyzes (or begins to analyze) relative movement data received from the accelerometer. One issue with a handheld sensor having an accelerometer is that the accelerometer could be constantly sending relative movement data as the device is being carried and placed. Accordingly, such tamper detection monitoring aspects can be initiated after arming or placing the device, or otherwise indicating to the device to begin tamper monitoring reporting and/or tamper detection data recording for subsequent reporting. An accelerometer in a given sensor device can be constantly active in sending movement data to a CPU of the device, but until initiating a tamper detection monitoring mode, the sensor device (or CPU of the device) ignores or otherwise does not receive data signals from the accelerometer.

Movement path 201 of FIG. 2 represents tampering activity. Note that in this particular example, such movement activity represents the device being transported from one geographical location to another geographical location, but tampering could result in the device remaining approximately in the same location (the device fell from a tree, the device was stepped on, the device was discovered and examined but left at its location). Regardless of the type of relative device movement, location 221 represents that sensor device 100 has detected relative movement data above a predetermined threshold, that is, a change is device movement or acceleration meeting a specific threshold. In response, to detecting tampering, sensor device 100 enters tamper detection response state 220, which is a device mode that executes one or more actions in response to the detected tampering. Accordingly, upon detecting that the device has been moved/tampered with, the device can immediately notify (if connected to a communication network) that the device has been tampered with. The device can optionally send multiple messages to help ensure that the tamper detection notification was received at a corresponding control center or authorized peer device 200.

Optionally, the device sensors that sense external activity (activity separate from relative movement of the device) can be shut-off, disabled, or reduced in sensing functionality. The device can also transition to a low-power mode to conserve battery power. Thus, whatever the sensing function is, this functionality can be disabled because such sensing functions are typically a significant power draw for battery-powered devices. In addition to shutting down sensing functions to conserve power, another reason is to avoid detection that the device is still on. Any given device can have various reporting modes such as constant reporting or event-based reporting. In either case, such reporting can be disabled after detecting tampering to prevent detectable radio transmissions.

Sensor devices can optionally include Global Positioning System (GPS) modules. In such GPS-equipped sensor devices, another part of the tamper detection response is to get a GPS fix. The device can also get fixes as the device is being transported, or get GPS fixes based on time (periodic fixes) to be able to track the device for subsequent recovery. GPS tracking can include a combination of both time-based GPS fixes and movement-based fixes. For example, data from the accelerometer can be used as a basis for when to take GPS fixes, such as during detected manual movement or transportation. Tracking can be based on both the GPS device and the accelerometer data. The GPS module can use more power than other modules, and so acquiring GPS fixes can be conservative in amount and frequency. GPS information is beneficial in case a moved sensor device is taken to a safe house to be disassembled or to construct a bomb with the device. Depending on the type of sensor, such sensing device can be costly to replace, so such GPS tracking can aid in recovery of a stolen or removed device. Location 222 represents a subsequent location after being moved from location 221 along path 202. Note that at location 222, sensor device 100 is still in tamper detection response state 220.

If the GPS antenna from the sensor device was removed, the device may not know its geographical location. In situations where GPS functionality has been compromised, signal strength of the device (as detected by a peer device) can instead be used to triangulate a location of the device. The tampered with device can then transmit information to a point of recording. This can include timestamps to determine when GPS functionality ceased.

Recovering a sensor device can be important not only from a cost perspective, but also to restore a given sensing data source or repair a hole in a sensing network. Such compact radar devices (or seismic, acoustic and other sensors) can optionally be deployed in groups to form a network, chain, or array of radar nodes. Each radar node can communicate with neighboring radar nodes to communicate collected radar data. An example capability of such a network is detection and tracking of humans in difficult sensing environments. A system of networked compact radar sensors can provide critical advanced warning of intruders in situations where detection time is critical. Thus, it can be important to maintain proper sensing functionality of a stand-alone sensor, or of a sensor that is a node within a sensing network.

With respect to network connectivity, part of the transition to the low-power mode can include transitioning to a listen-only mode. In listen-only mode, the sensor device is waiting to hear from an authorized peer device or friendly device before attempting to transmit recorded data. Thus, the sensor device can be interrogated (requesting device location) by a friendly device that is either part of a device array/chain, or that is scouting for the tampered device. For example, sensor device 100 at location 222 receives an interrogation ping from authorized peer device 222. Sensor device 100 then transmits data collected as part of the tamper response. This can include relative movement data, GPS data, audio/visual data, etc. In the low-power mode when executing tracking, if the sensor device stays on a corresponding network then the device can continue reporting. If removed from the network then the sensor could cease wireless reporting. Depending on the radios and environment this could be a few hundred meters to a couple of miles. Listening can also use up power, so the listen-only mode can executed as periodic listening. The device can be listening for another radio that belongs on the network. When a peer radio gets close enough so that the device can receive pings from the peer device, then the tampered with device can transmit data/location information according to a time sync (if the radios operate using a time syncs). For example, a person can simply drive around a suspected area transmitting pings until receiving a response from a tampered with sensor device.

As noted above, tampering can be inadvertent or purposeful. For example, a person may physically remove or steal a sensor from a placement location, or an animal may bump or knock over the sensor while looking for food. In scenarios in which a device is simply bumped or jarred, subsequent reports from the sensor device can indicate positively that the device was tampered with, but that the device was not substantially moved from its placement area. The device can also indicate tamper duration, such as whether detected tampering last about a few seconds and then ceased, or if the tampering spanned several hours or more. If the tampering lasted a very short duration, then the chances of the sensor device being dangerous or compromised are lower. If, however, the tamper duration lasted several hours or days, then the chances of a device being dangerous are higher—especially if the device was transported and then returned. Relative movement data can also indicate how the device was moved, whether the device was picked-up, dropped, bumped, transported, etc. Accordingly, if it is determined that the relative device movement was not substantial and the placement is still acceptable, then the device can be permitted back on any corresponding network and returned to a tamper monitoring state. The data can also indicate that the device is most likely safe, but that the device needs to be repositioned for accurate sensing functionality.

In other embodiments, tamper detection response state 220 can include taking audio and/or video recordings. For example, a microphone can be left on to capture audio recordings. Another action is that in response to detecting that the sensor device is compromised, the device can be wiped of data such as by dumping the software encryption keys or otherwise rendering the device useless to unauthorized individuals.

While cost and safety are important reasons for recovering transported sensor devices, another important reason for detecting tampering is to cover a gap in the sensor coverage (a hole in the network or array), which needs to be replaced. Compact sensor devices can be deployed as part of a network, such as a wireless ad hoc network. Accordingly, positioning a unit appropriately and having a unit remain undisturbed can be important for network connectivity.

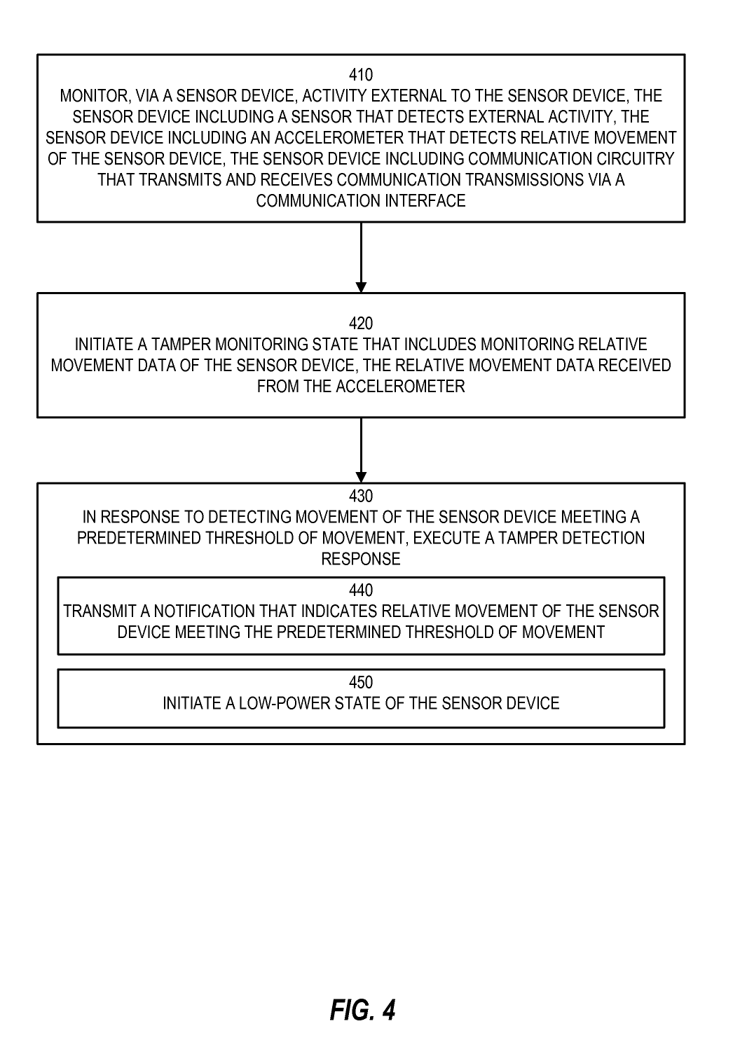

Functionality associated with the tamper manager will now be discussed via flowcharts and diagrams in FIG. 4 and FIGS. 5-6. For purposes of the following discussion, the tamper manager or other appropriate entity performs steps in the flowcharts.

Now describing embodiments more specifically, FIG. 4 is a flow chart illustrating embodiments disclosed herein.

In step 410, a sensor device monitors activity external to the sensor device. The sensor device includes a sensor that detects external activity, an accelerometer that detects relative movement of the sensor device, and communication circuitry for transmitting and receiving communication transmissions via a communication interface. The activity external to the sensor device can include movement of objects or people that can be detected by a radar or infrared sensor, seismic waves that propagate through the earth, acoustic activity such as speech or gunshots, etc. Such external activity can be detected as input of electromagnetic waves, seismic waves, visible light, sound waves, and so forth. Thus, the sensor can comprise a sensor that measures electromagnetic waves or mechanical waves. Monitoring activity external to the device can be executed after the sensor device is positioned in a desirable physical location.

In step 420, tamper manager initiates a tamper monitoring state that includes monitoring relative movement data of the sensor device. The relative movement data is received from the accelerometer. More specifically, the tampering monitoring state includes monitoring for changes in acceleration of the device or changes in device movement relative to a given frame. Typically devices will be positioned at a stationary location relative to the earth, and so the device can monitor for any movement relative to that reference frame. The tamper monitoring state can optionally include disabling use of a manual power shutoff switch of the sensor device. The power shutoff can be disabled before or after initiating the tamper monitoring state, such as part of a device arming response. Thus, while the sensor can monitor and detect external inputs and movements, the accelerometer (or other relative motion detecting means such as a tilt switch or mercury switch) detects relative movement or acceleration of the sensor device itself.

In step 430, in response to detecting movement of the sensor device meeting a predetermined threshold of movement, the tamper manager executes a tamper detection response. The predetermined threshold of movement can be configured based on acceptable movement for a given sensor application, and/or movement that suggests human interaction. For example, some sensors can be more sensitive to slight movements as compared to other types of sensors. The predetermined threshold of movement can represent a change in acceleration or rate of change of device movement.

In step 440, the tamper manager transmits a notification that indicates relative movement of the sensor device meeting the predetermined threshold of movement. This notification can be immediate or delayed depending on a sensor device placement location. If a given sensor device is deployed as part of a network, then such a notification can be sent immediately via network connectivity. If the sensor device is operating outside of a network, then the sensor device may need to wait until receiving a request from an authorized peer device. This notification can be transmitted via a radio module, or a wired communication connection.

In step 450, the tamper manager initiates a low-power state of the sensor device. The low-power state can include various device and power modifications.

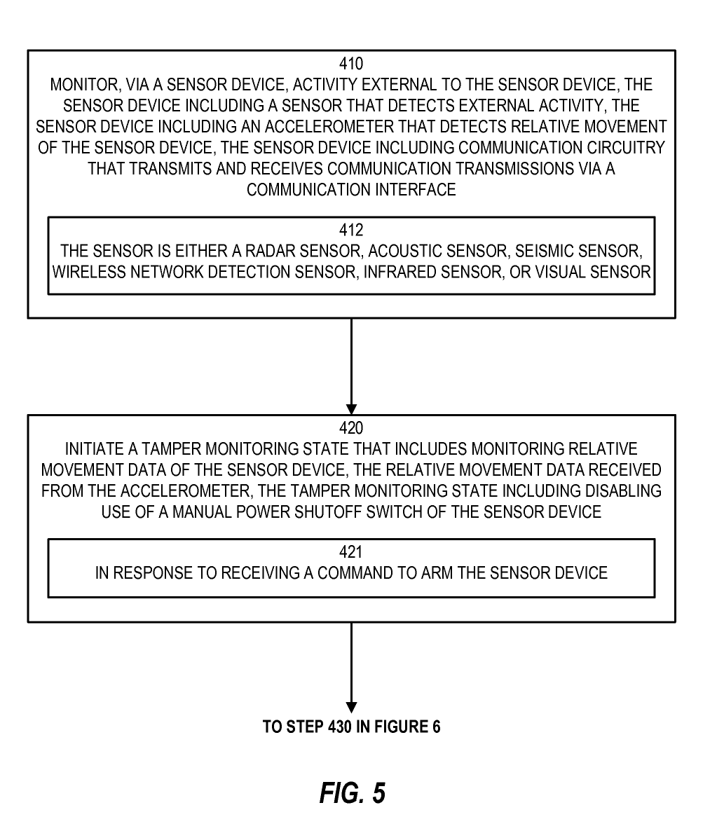

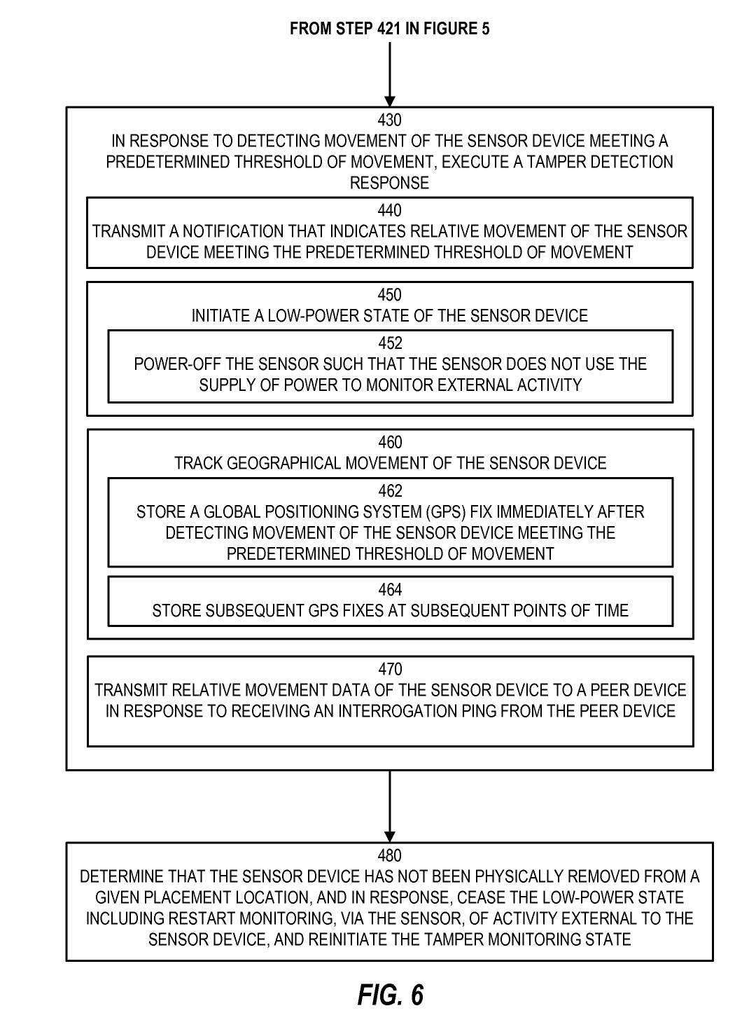

FIGS. 5 and 6 include a flow chart illustrating additional and/or alternative embodiments and optional functionality of the tamper manager as disclosed herein.

In step 410, a sensor device monitors activity external to the sensor device. The sensor device includes a sensor that detects external activity, an accelerometer that detects relative movement of the sensor device, and communication circuitry for transmitting and receiving communication transmissions via a communication interface.

In step 412, the sensor of the sensor device can be a radar sensor, acoustic sensor, seismic sensor, wireless network detection sensor, infrared sensor, or visual sensor. The sensor device can also include combinations of these types of sensors.

In step 420, tamper manager initiates a tamper monitoring state that includes monitoring relative movement data of the sensor device. The relative movement data is received from the accelerometer. The tamper monitoring state can include disabling use of a manual power shutoff switch of the sensor device.

In step 421, the tamper manager initiates the tamper monitoring state in response to receiving a command to arm the sensor device. Thus, prior to completing placement (such as initial geographic placement) of the sensor device, the sensor device does not act on any data received from the accelerometer.

In step 430, in response to detecting movement of the sensor device meeting a predetermined threshold of movement, the tamper manager executes a tamper detection response.

In step 440, the tamper manager transmits a notification that indicates relative movement of the sensor device meeting the predetermined threshold of movement. Transmitting the notification can include transmitting multiple notifications via a communication network immediately after detecting relative movement of the sensor device meeting the predetermined threshold of movement.

In step 450, the tamper manager initiates a low-power state of the sensor device.

In step 452, the tamper manager powers-off the sensor such that the sensor does not use the supply of power to monitor external activity. For example, the tamper manager causes the device to stop collecting radar data or seismic data. Alternatively, this can include disabling scheduled reporting of external activity data collected via the sensor, when the external activity data is scheduled for transmission via a communication network.

In step 460, the tamper manager tracks geographical movement of the sensor device, such as by using a GPS module. In step 462, the tamper manager stores a Global Positioning System (GPS) fix immediately after detecting movement of the sensor device meeting the predetermined threshold of movement. In step 464, the tamper manager stores subsequent GPS fixes at subsequent points of time. Storing subsequent GPS fixes at subsequent points of time can be based on relative movement data of the sensor device.

In step 470, the tamper manager transmits relative movement data of the sensor device to an authorized peer device in response to receiving an interrogation ping from the peer device. The sensor device can also transmit GPS information of the sensor device to the peer device in response to receiving a request for a current location. Transmitting information can indicate movement information over a specified period of time, which can be used to determine how quickly the sensor device is being moved to another location. The peer device can be an authorized device or friendly device recognized by the sensor device. This can include any conventional authorization technique. Thus, after verifying a signal from a peer device as trustworthy, the sensor device can respond.

In step 480, the tamper manager determines that the sensor device has not been physically removed from a given placement location, and in response, ceases the low-power state including restarting monitoring, via the sensor, of activity external to the sensor device, and reinitiating the tamper monitoring state. In other words, if the device (or unit that remotely controls the device) determines that the relative movement was inconsequential or unsuspicious (such as a minor bump), then the sensor device can return to a regular sensing mode and stop the tamper response activities. Alternatively, the tamper manager can receive instructions from a peer device or command control unit, via a communication network, to cease the tamper detection response. The instructions from the peer device can be based on duration of relative movement of the sensor device and location of the sensor device.

In another embodiment, the sensor device can have a first power consumption rate prior to detecting tampering, and have a second power consumption rate after entering the tamper detection response state, such that the first power consumption rate is different than the second power consumption rate. The tamper detection response can include recording audio data of external activity. Such a response can be used to record conversations of unauthorized individuals. Thus, in addition to tamper detection responses lowering a power consumption rate of the sensor, the sensor device can periodically acquire and store audio data, image data and/or video data, such as while the sensor device is being moved by an unauthorized individual. Upon recovery of the sensor device, audio, video and/or image data stored in memory can be accessed and processed in order to learn the approximate route of the unauthorized displacement. Note, however, that it is not required that the sensor device be actually recovered in order to access such location data, audio data, video data and/or image data. Rather, in various embodiments, any type of data can be downloaded from sensor device via a network or radio transmission.

The sensor device can also have different rates of acquiring GPS fixes. For example, rates of GPS fixes can be different during the tampering monitoring state as compared to the tamper detection response state. Moreover, rates of GPS fixes can be different based on an amount of time since detecting device tampering. For example, GPS fixes can be acquired at a first rate for 24 hours since detecting device tampering, and the switch to a second (possibly lower rate) after 24 hours since detecting device tampering. Additionally, in some embodiments, the sensor device does not obtain GPS fixes until after detecting device tampering.

Returning to FIG. 3, FIG. 3 depicts a block diagram 305 of a sensor device 100. Sensor device 100 can be embodied as a stand-alone sensor, or operate in conjunction with peer devices and/or a wired or wireless network, and also function as a node of that network. The sensor device 100 includes power sequencing circuitry 326, which is used to provide, sequence, and control power to various other components of the system in combination with Power Circuitry 325. The power circuitry 326 can be armed and disarmed with respect to a position of an external power switch 135, or based on a separate communication received from a network or peer device. A power source 327 can include one or more batteries. Sensor device 100 also includes radio module 324 having a port 322 for a wireless communication antenna (e.g., a Low Energy Network (LEN) antenna). Radio module 324 and antenna are used to provide wireless network communication with other wireless systems.

A Radar RF module 312 is also shown having a port 320 for radar antenna 110. Also shown is a Global Positioning System (GPS) module 334, which is used to provide location information regarding the device 100. Device 100 further includes clock distribution circuitry 328 for distributing and synchronizing various clocks across the device 100. An Analog to Digital Converter (ADC) 318 is included and a wakeup timer circuit is used for controlling various components according to when respective components should be active, such as in power management.

Sensor device 100 also includes memory circuitry 330, which is used for storing various state and acquired information (e.g. radar events, audio data, video data, GPS position data (or the like)) for later retrieval and/or transmission. In this example, memory is shown as 330-1 Flash and 330-2 SDRAM. Also shown is Field Programmable Gate Array (FPGA) 316 and Digital Signal Processor (DSP) 314. Note that though described as a digital signal processor, item 314 can be embodied as any generic processor. A vibrator or vibrator motor 374 can be coupled to sensor device 100. Vibrator 374 can be any conventional vibration motor or vibration technique. Device 100 can also include circuitry and interfaces for external inputs and outputs, such as serial connections, Ethernet, USB, Bluetooth, etc. Accelerometer 377 is also coupled to the device. Accelerometer 377 can include one or more accelerometers that function together. Accelerometer 377 is configured to detect relative motion of the device itself. Relative motion of the device itself can include being lifted, turned, rotated, shaken, bumped, moved, etc. Conventional accelerometers can be used.

The memory 330 can include instructions for the processor (such as digital signal processor 314) to execute a tamper manager process and application.

Operational software in the nodes(s) is executed on the DSP 314, which also functions as the microcontroller in the system. Radar processing, initiation of power management, radio, GPS, vibrator control, etc. can all be run by software executed by the DSP 314. Note that an actual configuration for carrying out the tamper manager can vary depending on a respective application. For example, sensor device 100 can include one or multiple computers or computer processors that carry out the processing as described herein. In alternative embodiments, sensor device 100 can be any of various types of networking devices. A communications interface enables the tamper manager of sensor device 100 to communicate over a network and, if necessary, retrieve any data required to indicate status according to embodiments herein. The memory system can be encoded with the tamper manager that supports functionality as described above and as described further below. The tamper manager (and/or other resources as described herein) can be embodied as software code such as data and/or logic instructions that support processing functionality according to different embodiments described herein.

During operation of one embodiment, a processor accesses the memory system via the use of a wired or wireless interconnect to launch, run, execute, interpret or otherwise perform the logic instructions of the tamper manager. Execution of the tamper manager produces processing functionality. In other words, the tamper manager process represents one or more portions of the tamper manager performing within or upon the processor in the sensor device 100.

It should be noted that, in addition to the tamper manager process that carries out method operations as discussed herein, other embodiments herein include the tamper manager itself (i.e., the un-executed or non-performing logic instructions and/or data). The tamper manager may be stored on a non-transitory, tangible computer-readable storage medium including computer readable storage media such as floppy disk, hard disk, optical medium, etc. According to other embodiments, the tamper manager can also be stored in a memory type system such as in firmware, read only memory (ROM), or, as in this example, as executable code within the memory system. In addition to these embodiments, it should also be noted that other embodiments herein include the execution of the tamper manager in the processor as the tamper manager process. Thus, those skilled in the art will understand that the sensor device 100 can include other processes and/or software and hardware components, such as an operating system that controls allocation and use of hardware resources, or multiple processors.

Those skilled in the art will also understand that there can be many variations made to the operations of the techniques explained above while still achieving the same objectives of the invention. Such variations are intended to be covered by the scope of this invention. As such, the foregoing description of embodiments of the invention are not intended to be limiting. Rather, any limitations to embodiments of the invention are presented in the following claims.

1. A sensor device comprising:
a processor;
power circuitry configured to receive a supply of power;
a sensor configured to detect activity external to the sensor device;
an accelerometer configured to detect relative movement of the sensor device; and
a memory coupled to the processor, the memory storing instructions that, when executed by the processor, cause the sensor device to perform the operations of:
monitoring, via the sensor, activity external to the sensor device;
initiating a tamper monitoring state that includes monitoring relative movement data of the sensor device, the relative movement data received from the accelerometer;
in response to detecting movement of the sensor device meeting a predetermined threshold of movement, executing a tamper detection response, the tamper detection response comprising:
transmitting a notification that indicates sensor device movement meeting the predetermined threshold of movement; and
initiating a low-power state of the sensor device.

2. The sensor device of claim 1, wherein the tamper detection response further comprises tracking geographical movement of the sensor device.

3. The sensor device of claim 2, wherein tracking geographical movement of the sensor device comprises:
storing a Global Positioning System (GPS) fix immediately after detecting movement of the sensor device meeting the predetermined threshold of movement; and
storing subsequent GPS fixes at subsequent points of time.

4. The sensor device of claim 3, wherein storing subsequent GPS fixes at subsequent points of time is based on relative movement data of the sensor device.

5. The sensor device of claim 1, wherein the tamper detection response further comprises:
receiving an interrogation ping from a peer device;
in response to receiving the interrogation ping, transmitting relative movement data of the sensor device to the peer device.

6. The sensor device of claim 5, wherein the tamper detection response further comprises:
in response to receiving the interrogation ping, transmitting Global Positioning System (GPS) location information of the sensor device to the peer device.

7. The sensor device of claim 1, wherein initiating the low-power state of the sensor device comprises:
powering-off the sensor such that the sensor does not use the supply of power to monitor external activity.

8. The sensor device of claim 7, wherein initiating the low-power state of the sensor device further comprises:
disabling scheduled reporting of external activity data collected via the sensor, the external activity data scheduled for transmission via a communication network.

9. The sensor device of claim 1, wherein transmitting the notification includes transmitting multiple notifications via a communication network immediately after detecting relative movement of the sensor device meeting the predetermined threshold of movement.

10. The sensor device of claim 1, wherein initiating the tamper monitoring state occurs in response to receiving a command to arm the sensor device; and
wherein the tamper monitoring state includes disabling use of a manual power shutoff switch of the sensor device

11. The sensor device of claim 10, wherein the sensor is a type of sensor selected from the group consisting of radar sensor, acoustic sensor, seismic sensor, wireless network detection sensor, infrared sensor, and visual sensor.

12. The sensor device of claim 1, wherein the memory stores further instructions that, when executed by the processor, cause the sensor device to perform the operation of:
in response to determining that the sensor device has not been physically removed from a given placement location, ceasing the low-power state including restarting monitoring, via the sensor, of activity external to the sensor device, and reinitiating the tamper monitoring state.

13. The sensor device of claim 1, wherein the memory stores further instructions that, when executed by the processor, cause the sensor device to perform the operation of:
in response to receiving instructions from a peer device via a communication network, ceasing the tamper detection response including restarting monitoring of activity external to the sensor device and returning to the tamper monitoring state by restarting monitoring of sensor device movement data received from the accelerometer, wherein the instructions from the peer device are based on a duration of relative movement of the sensor device and location of the sensor device.

14. A radar sensor device comprising:
power circuitry configured to receive a supply of power from at least one battery;
a radar signal transmitter configured to transmit radar signals;
a radar signal receiver configured to receive reflected radar signals;
a processor, the processor configured to compute radar data from received reflected radar signals such that computed radar data includes a distance to an external object;
radio circuitry configured to execute wireless communication events including communication transmissions with peer devices;
Global Positioning System (GPS) circuitry configured to identify location information of the radar sensor device;
an accelerometer configured to detect relative movement of the radar sensor device; and
a memory coupled to the processor, the memory storing instructions that, when executed by the processor, cause the radar sensor device to perform the operations of:
collecting radar data that identifies distance of external objects;
initiating a tamper monitoring state that includes monitoring relative movement data of the radar sensor device, the relative movement data received from the accelerometer, the tamper monitoring state including disabling use of a manual power shutoff switch of the radar device;
in response to detecting relative movement of the radar sensor device meeting a predetermined threshold of movement, executing a tamper detection response, the tamper detection response comprising:
immediately transmitting a notification via the radio circuitry, the notification indicating radar sensor device movement meeting the predetermined threshold of movement; and
initiating a low-power state of the radar sensor device that includes reducing power consumption of the radar signal transmitter and the radar signal receiver.

15. The radar sensor device of claim 14, wherein the tamper detection response further comprises tracking geographical movement of the radar sensor device by storing a Global Positioning System (GPS) fix immediately after detecting movement of the radar sensor device meeting the predetermined threshold of movement, and by storing subsequent GPS fixes at subsequent points of time.

16. The radar sensor device of claim 14, wherein the tamper detection response further comprises:
receiving an interrogation ping from a trusted peer device;
in response to receiving the interrogation ping, transmitting relative movement data of the radar sensor device to the trusted peer device and transmitting Global Positioning System (GPS) location information of the radar sensor device to the trusted peer device.

17. The radar sensor device of claim 14, wherein the memory stores further instructions that, when executed by the processor, cause the radar sensor device to perform the operation of:
in response to determining that the radar sensor device has not been physically removed from a given placement location, ceasing the low-power state including restarting monitoring of activity external to the radar sensor device and reinitiating the tamper monitoring state.

18. The radar sensor device of claim 14, wherein the tamper detection response further comprises recording audio data of external activity.

19. A computer-implemented method of tamper detection, the computer-implemented method comprising:
monitoring, via a sensor device, activity external to the sensor device, the sensor device including a sensor that detects external activity, the sensor device including an accelerometer that detects relative movement of the sensor device, the sensor device including communication circuitry that transmits and receives communication transmissions via a communication interface;
initiating a tamper monitoring state that includes monitoring relative movement data of the sensor device, the relative movement data received from the accelerometer, the tamper monitoring state including disabling use of a manual power shutoff switch of the sensor device;
in response to detecting movement of the sensor device meeting a predetermined threshold of movement, executing a tamper detection response, the tamper detection response comprising:
transmitting a notification that indicates relative movement of the sensor device meeting the predetermined threshold of movement; and
initiating a low-power state of the sensor device.

20. The computer-implemented method of claim 19, wherein the tamper detection response further comprises tracking geographical movement of the sensor device by storing a Global Positioning System (GPS) fix immediately after detecting movement of the sensor device meeting the predetermined threshold of movement, and by storing subsequent GPS fixes at subsequent points of time;
wherein initiating the low-power state of the sensor device includes powering off the sensor such that the sensor does not use the supply of power to monitor external activity;
wherein transmitting the notification includes transmitting multiple notifications, via the communication interface, immediately after detecting relative movement of the sensor device meeting the predetermined threshold of movement; and
wherein the sensor is a type of sensor selected from the group consisting of radar sensor, acoustic sensor, seismic sensor, wireless network detection sensor, audio sensor, and video sensor.
